(19) United States
(12) Patent Application Publication
(10) Pub. No.: US 2003/0050838 A1
(43) Pub. Date: Mar. 13, 2003

(54) Communication system for managing premium points exchangeable among different virtual shops

(76) Inventors: Ken Suzaki, Tokyo (JP); Kazuhiro Hayashi, Kanagawa (JP)

Correspondence Address: Kanesaka & Takeuchi, 1423 Powhatan Street, Alexandria, VA, 22314, US

(21) Appl. No.: 10/221,389

(22) PCT Filed: Nov. 9, 2001
(86) PCT No.: PCT/JP01/09810

(30) Foreign Application Priority Data
Nov. 9, 2000 (JP) 2000-342697

(51) Int. Cl. G06F 17/60

(52) U.S. Cl. 705/14

(57) ABSTRACT

According to this invention, it is possible for a general server to manage, by using an Internet, point distribution between virtual shops belonging to different local servers without imposing any complicated works on the local servers, and for a customer to make a shopping at more virtual shops than would be possible if the local network to which the customer belongs remained independent.

According to this invention, a local server's web site communication system 10 manages/handles point distribution service on behalf of individual virtual shops under its coverage, and, when a customer receives a point from a shop in its network, receives his/her ID signal, date when he/she received the point, and the ID of the shop which published the point, and transmits those data to a general server. The customer (via a cellular phone or a small, general-purpose computer) receives a point after a purchase at a virtual shop in the local network through the intervention of the local server's web site communication system 10, and uses the point for a next purchase at another shop belonging to another local network. A general server's web site communication system 4 receives point data from involved local servers' web site communication systems 10, and determines the points published and received for the two shops, and calculates the subtractions for storage.

### TECHNICAL FIELD

This invention relates to a management method of premium points useful for a plurality of virtual shops working on a computer-based bidirectional communication network, whereby premium points exchangeable among different virtual shops are safely managed through a computer-based bidirectional communication network operating under a TCP/IP (transmission control protocol/Internet protocol) environment, thereby enabling the individual virtual shops to securely capture their respective customers, and to take advantage of the attributes or the customers for promoting further sale, and a system for managing premium points exchangeable among different virtual shops.

### BACKGROUND ART

Conventionally, the shop has practiced sales promoting activities (services) consisting of providing its customers with premium points or stamps. Specifically, in order to attract the customers' attention or to capture a stable group of customers, the shop provides the customer with an appropriate number of point notes, depending on the sum of his/her purchase, and, when the accumulated points reaches a certain level, the shop provides the customer with service consisting, for example, of discounting, or presenting a shop good or a certain special gift. Similarly, the shop may provide a customer with a number of seals depending on his/her purchase, so that the customer may paste the seals on a board, and, when the boards having their blank space filled with seals reaches a certain number, the shop provides the customer with service consisting, for example, of discounting, or presenting a shop good or a certain special gift. This constitutes an element of the sales promoting activity (service) of the shop.

Provision of such point notes or seals has been practiced by individual shops, agents specialized in the job, and associations (for example, merchant associations), in such a way as to effectively promote the sale. Usually, agents and associations obtain margins depending on the amount of point notes and seals they distributed on behalf of the contracting shops. However, the sales activity depending on human labor such as delivery of point notes or seals and pasting seals on a board requires a considerable time and cost (for printing point notes, seals and boards, to mention a few). To meet such a problem, electronic systematization was introduced. Thus, electronic systems incorporating a POS (point of sales) system or an ECR (electronic cashless register) have been proposed for smoothening the work involved in the sales activity. According to such a sales system based on POS or ECR, a system operator publishes, in response to a request from a customer, to the customer a magnetic card or IC card bearing his/her ID.

Each time the customer presents his/her card to a member shop prior to payment, the shop adds points according to the sum of purchase. The magnetic/IC card is fed, for example, into a reader dedicated for the purpose, and whenever a sum for the purchase is fed manually, or automatically through a register, to the system which then calculates the points to be added for the purchase in question, and stores involved data. The thus determined points to be added for the purchase are managed, together with other data of the customer including his/her application, by a host computer located at a head-office of the shop or at a supervising association. The shop then provides the customer with information of the discount or a good he/she deserves to receive, and tells him/her where the good is, through a display in the shop, or a handout, so that the customer may smoothly receive the service he/she deserves. Information of the attributes of customers is classified and assigned to appropriate segments, and direct advertising mails appropriately selected in accordance with the data of individual customers are distributed, to thereby further promote the sale.

Sales may be achieved by shops working on a domestic network or on an international network, such as a computer-based bidirectional communication network operating under a TCP/IR environment, e.g., an Internet or extranet. Such a shop is called a virtual shop. Japanese Patent Laid-Open No. 10-78982 titled “Point service system of a virtual shopping center” discloses a system-based processing of premium points exchanged between customers and individual shops.

### DISCLOSURE OF INVENTION

The conventional sales activity as described above, i.e, delivery by hand of point notes, and seals and boards, or simple electronic substitution thereof will not match with the activity anticipated from a recent virtual shop working on an Internet. With regard to the point service system based on an Internet disclosed by the above laid-open patent, it ensures a certain advantage if it is practiced by a virtual shop working on an Internet, indeed. For example, the shop can provide a customer with service such as delivery of premium points, without requiring him/her to come to the shop after having paid fee for transportation, nor to present his/her magnetic/IC card. This is advantageous because of its enabling the reduction of cost and time.

However, this point service system on an Internet has no explicitly given facility which would be required for further integral management if the shop had to be connected to another shop working on a network managed by a different server. Thus, a shop on this system could not make available more sophisticated services which are ensured by the Internet's open publicity. For example, with such a system, if a customer receives premium points from a shop, and wants to use the points for the next purchase from another shop, it would be impossible if the two shops belong to networks managed by different servers because then the points of the former shop are not valid for the latter. Therefore, if the customer wants to make discounted purchase in shopping of a variety of goods, he/she must contract with numerous network systems, which will be cumbersome.

To serve as a solution to this problem, a retailer provides a “widely accessible point service” in which the customer at any web site can receive points through purchase from the retailer. However, this service providing system will be objectionable for a shop which wants to be specialized in its sale of quality goods to establish its reputation. A solution to this problem will be provided by introducing an association (general server) which will manage data necessary for point distribution on behalf of individual local servers each independently comprising a number of virtual shops, so that points published by a shop under a local server are made exchangeable among other shops belonging to different local servers. In this scheme, however, if a customer receives points from a shop and uses the points for the next purchase from another shop belonging to a different local server, how the balance between the two shops should be made is not clearly defined. Thus, still under this sheme, it will be impossible for points published by shops belonging to different local servers to be exchangeable with each other, or for customers belonging to different local servers to exchange their points.

By the way, E-mails have been widely used by retailers as a means to directly distribute information of their goods (information regarding goods to be marketed, and advertisement and guide of marketed goods) among consumers. Information distribution via E-mail is performed exclusively from the side of information providers, and thus, useful information is so inextricably mixed with useless information that the consumer hardly tell useful information from useless information. To avoid this situation, an “opt-in mail system” was introduced in which the consumer registers in advance his/her fields of interest, so as to receive only the mails that fit his/her fields of interest.

Even the “opt-in mail system” is not devoid of flaws: under this system, it is impossible to update the attributes of individual consumers or to follow the change of the consumers' fields of interest over time, and thus for the virtual shop to advance a proper, to-the-point direct (permission) marketing towards consumers, in accordance with the current fields of interest of the consumers.

This invention is provided as a solution to the above problems encountered with the prior art, and its object is to propose a management method of premium points useful for a plurality of virtual shops working on a computer-based bidirectional communication network, whereby, by using a computer-based bidirectional communication network operating under a TCP/IP (transmission control protocol/Internet protocol) environment, a general network server (integrative management web site) serves as an association of a plurality of local networks to manage point distribution works on behalf of them, in such a way as to allow points published by a shop to be usable in another shop belonging to a different network, by enabling the balance between the two shops to be properly calculated without requiring a complicated work therefor, and a system for managing premium points exchangeable among shops belonging to different networks.

Another object of this invention is to provide a management method of premium points useful for a plurality of virtual shops working on a computer-based bidirectional communication network, and a system for managing premium points exchangeable among shops belonging to different networks, whereby the customer can utilize points published by a larger number of shops than would be possible if he/she belongs only to a local network.

A still further object of this invention is to provide a management method of premium points useful for a plurality of virtual shops working on a computer-based bidirectional communication network, and a system for managing premium points exchangeable among shops belonging to different networks, whereby different, independent networks are managed by a general server, and individual subscribers of the networks (individual virtual shops) can obtain information of the attributes of new customers by referring to the point utilization data provided by the general server, thereby being able to effectively deliver in a timely manner to those customers E-mails properly tuned to them.

To serve as a solution to the above problems, a management method further provided by this invention of premium points useful for a plurality of virtual shops working on a computer-based bidirectional communication network is characterized by that: a customer obtains points from a shop under the management of a general server at its integrative management web site; and the management work comprises the steps of exchanging points among different shops in the same network, and exchanging points among shops in different networks, of receiving data, if a customer wants to receive a service from a shop based on the points he/she has received, regarding the ID of the customer transmitted by his/her communication unit, date when the service will be provided, ID of the shop providing the service, and the number of points the customer are ready to offer for receiving the service, and of storing those data.

This invention still further provides a method whereby a customer can hand out his/her points to another customer in exchange for money or equivalent points valid to another shop in a transaction performed on the homepage at the integrative managing web site, and then the general server at the integrative managing web site can add appropriate corrections to the existent points of the point-seller, and, when points of different shops are exchanged, to the points of the shops whose points were involved in the transaction.

This invention still further provides a method whereby, if the transaction consists of the exchange of points of two different shops, the exchange is achieved at a constant conversion ratio, or at a currently valid conversion ratio either of which is always displayed on the integrative managing web site; to be eligible to the transaction, the customer must subscribe to a network by sending, using his/her communication unit, a membership application carrying his/her personal attribute data through the integrative managing web site to the general server; and the personal attribute data are stored by the general server at the integrative managing web site to be readily available for direct marketing; and individual shops can gain the updated attribute information of individual customers by referring to the point publication data of individual shops, point exchanges among the customers, or the result of a marketing research based on questionnaire to sampled customers. Further, this method is suitable for each shop to advance permission marketing; the shop obtains the updated attribute data of a given customer, searches through advertisements using a data-base search engine to locate appropriate data for the customer, and to send an E-mail based on the advertisement data directly to the customer.

According to this invention, a general server (integrative managing web site) can effectively perform point management works for a plurality of local networks each containing an independent group of virtual shops, by using a computer-based bidirectional communication network operating under a TCP/IP environment (particularly Internet). Particularly, according to this invention, it is possible to make points published by a shop usable in another shop belonging to a different network, by enabling the balance between the two shops to be properly calculated. Moreover, because different networks each having an independent group of virtual shops are commonly managed by a general server according to this invention, a customer subscribing to such a local network can utilize more shops than is possible for a conventional customer whose network is isolated. Furthermore, a subscriber (each virtual shop of the networks) can obtain the updated attribute information of individual customers by tracing the point exchange transactions between the customers mediated by a general server organizing local networks, and can advance a direct marketing consisting of sending E-mails effectively prepared according to the current personal attributes of the customers.

A system of this invention for managing points exchangeable among different virtual shops by using a computer-based bidirectional communication network comprises a local server's web site communication means which performs point distribution on behalf of virtual shops, and receives, for each customer who receives points, the data regarding his/her ID, the date when he/she receives the points, the ID of the shop giving the points to the customer, etc., and sends the data to a general server; a customer's computer-based communication unit which receives the points from the virtual shop via the local server's web site communication means, and uses the points stored by the general server for the purchase at any desired virtual shop; and a general server's web site communication means which receives the data sent by the local server's web site communication means to store, and, for each transaction between shops belonging to different networks, finds the previously published points and the currently consumed points for the two shops, and determines by subtraction the resulting points 1or the two shops, and transmit the results to the relevant local servers.

The communication system of this invention is characterized by further comprising, on the computer-based bidirectional communication network, a network-based banking communication means which determines the price of a given good at a shop based on the point transaction introduced for the purchase, or which serves as a means for the determination; and a remote maintenance communication means which performs, from a remote site, the maintenance work of the general server's web site communication means. The system of this invention still further comprises, in the general server's web site communication means, a database unit which stores the attribute data sent from the computer-based communication unit via the general server's web site communication means and which allows a shop to search, for a given customer, through the database using a database search engine based on the attribute data of the customer, to locate appropriate advertisement data, thereby enabling the shop to advance a permission marketing consisting of sending an E-mail based on the thus selected data directly to the customer, wherein the computer-based communication means is a cellular phone incorporating an application enabling bidirectional communication, or a cellular phone not incorporating such an application, or a small general-purpose computer connectable to such a cellular phone.

According to this invention, the general server (integrative management web site) can manage point distribution between different local servers each containing a group of distinct virtual shops without requiring a complicated work therefor as achieved by the aforementioned methods; the customer subscribing to a local network can utilize more shops than is possible for a conventional customer whose network is isolated; and the subscriber (each virtual shop of the networks) can obtain the updated attribute information of a given customer, aid thus advance an effective, direct marketing towards the customer.

### BRIEF DESCRIPTION OF THE DRAWINGS

FIG. 1 is a block diagram to show the constitution of an embodiment of this invention.

FIG. 2 is a block diagram to show the constitution of a local network composed of virtual shops included in the embodiment.

FIG. 3 is a block diagram to show the constitution of the important components of a general server's web site such as a communication system included in the embodiment.

FIG. 4 illustrates the outline of the contents of Internet-based point integration service performed according to this invention.

FIG. 5 illustrates another embodiment representing a method for advertisement.

FIG. 6 is a block diagram of an embodiment to show how point ASP businesses are mutually related.

FIG. 7 illustrates an embodiment to show how Internet-based point integral management service is performed.

FIG. 8 illustrates an embodiment to show the procedures exchanged among the customer, EC web site and general server web site.

FIG. 9 illustrates an embodiment to show how points are exchanged.

FIG. 10 illustrates an embodiment to show the flow of steps necessary for point exchange.

FIG. 11 illustrates an embodiment to show the flow of steps necessary for the general server to exchange points between different local servers.

FIG. 12 illustrates an embodiment to show the flow of steps necessary for the general server to exchange points between different local servers.

FIG. 13 is a table-form figure of an embodiment to show a list of point conversion ratios.

FIG. 14 is a table-form figure of an embodiment to show another list of point conversion ratios.

### BEST MODE FOR CARRYING OUT THE INVENTION

The management method of this invention of points useful for a plurality of virtual shops working on a computer-based bidirectional communication network and system for managing premium points exchangeable among different virtual shops will be described below with reference to accompanying figures.

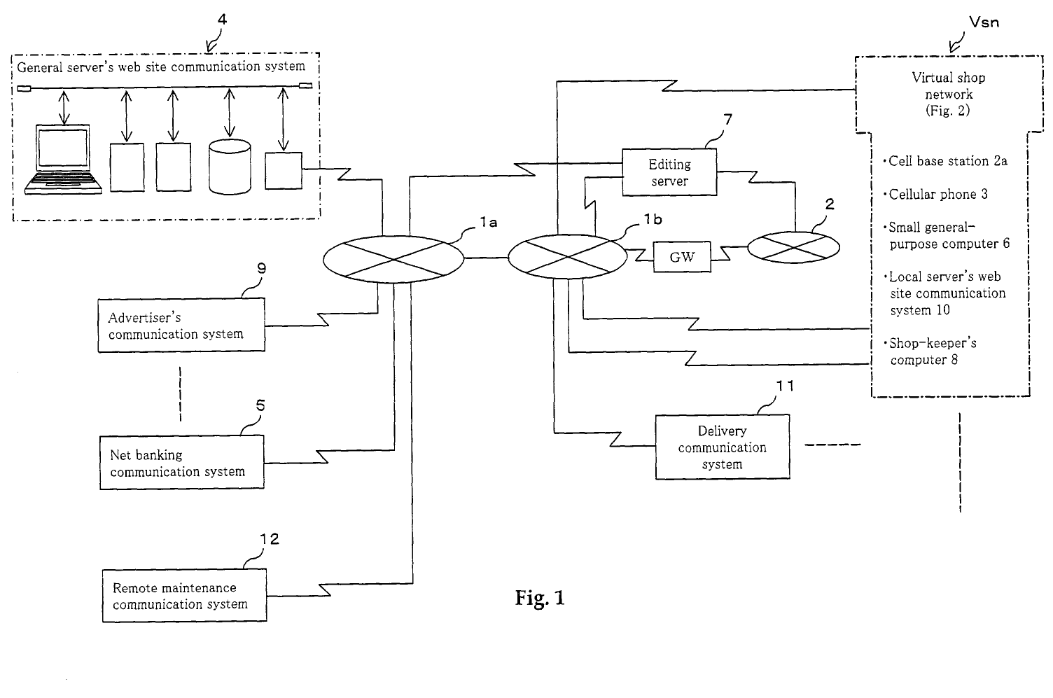

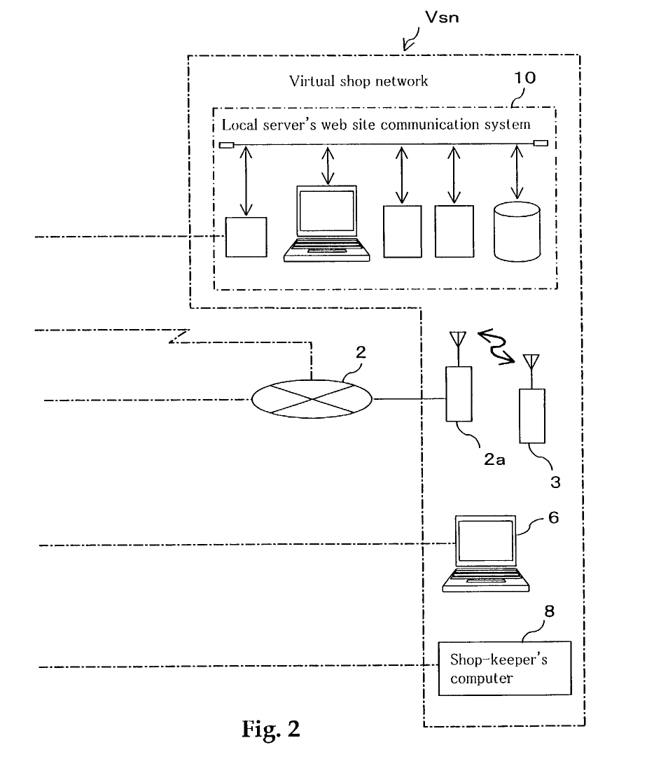

FIG. 1 is a block diagram to show the constitution of an embodiment of this invention, and FIG. 2 is a block diagram to show the constitution of a virtual shop network Vsn shown in FIG. 1.

The embodiment of the figures represents the constitution of a communication network operating under a TCP/IP environment (intranet, Internet, extranet, etc. all of which will be represented by an Internet hereinafter). This invention is not limited by the constitution of an Internet provided that the network is bidirectionally operable. For example, the Internet may operate on a communication protocol incorporating Y/Z-MODM, or it may comprise the communication network shown in FIG. 1 in connection with a retailer's intranet. Or, it may comprise a multi-media network provided with numerous gate-way equipment to transmit data through different kinds of media.

The Internet comprises a digital mobile communication network 2 connected to digital stationary communication networks 1a, 1b serving as an ISDN (Integrated Services Digital Network) via a gate-way equipment GW13 achieving communication protocol conversion. The digital mobile communication network 2 works on a PDC (Personal Digital Cellular Telecommunication System) mode or on a PHS (Personal Handyphone System) mode, and contains a cellular phone 3 to serve as a means to radio-communicate with a cell base station 2a. The cellular phone 3 can receive i-mode service currently available, and may comprise every portable communication means to be marketed in the future which will be connectable to an Internet through a wireless means. To the digital stationary communication network 1 is connected a general server web site communication system 4 which, as will be detailed later, serves as an integrative management web site communication means to integrally manage point exchange among individual local networks (corresponding to a virtual shop network Vsn).

The integrative management web site communication system 4 is connected, for example, to Internet service providers (ISP) each of which comprises a server and communication control equipment covering an independent local network. Which provider should be chosen is determined depending on the size of the network covered by the provider. When it is necessary to integrate a large number of local networks, it is recommended to assign part of the task to local servers, because then the handling and maintenance of large amounts of data will become easy.

The digital stationary communication network 1 contains a net banking communication system 5 assigned to a net bank which determines, when a customer buys a good, the price of the good as an “Internet-based service of integrative point management of this invention.” To the digital stationary communication network 1 are also connected numerous, small, general-purpose computers 6 as shown in FIG. 2 (cellular phones being similarly used by customers) to serve as a communication means by which the customer receives points through shopping at a virtual shop as an “Internet-based service of integrative point management of this invention,” or exchanges data at web sites encountered during Internet surfing.

Between the digital stationary communication network 1 and the digital mobile communication network 2 is inserted an adaptive editing server 7 which edits the content provided by the general server web site communication system 4 into a form adaptive to the small display of a cellular phone 3. To the digital stationary communication networks are further connected a shop computer 8 which is provided to a retailer to act as a virtual shop on the network; and an advertiser's communication system 9 provided to an enterprise which, on request from a shop, presents a banner advertisement on a virtual shop network Vsn or on the general server web site, or plans a permission marketing based on the attribute data of possible buyers to put it into practice.

To the digital stationary communication network 1 are further connected a local server web site communication system 10 to serve as a local web site communication means by which the local server achieves point distribution service for the virtual shops contained in its virtual shop network Vsn as shown in FIG. 2; a transporter's communication system 11 provided to a transporter which, receiving a request from a customer on Internet, delivers his/her purchased good to the customer; and remote maintenance communication equipment 12 which maintains, from a remote place, the general server web site communication system 4 as will be described later.

The general server achieves point exchange service between different virtual shop networks Vsn, by managing/operating those networks as their organizer (to be referred to as integrative management hereinafter) as shown in FIG. 2. Namely, the general server achieves “Internet-based service of integrative point management of this invention” using its communication system 4.

The digital stationary communication network 1 is an IP network having a known constitution and operating on a known communication protocol, in which packet exchange stations are disseminated. The digital stationary communication network 1 may be substituted for by an analog telecommunication network such as a PSTN (Public Switched Telephone Network). The digital mobile communication network 2 is a known mobile cell communication network working on ARIB-27/28 standard (PDC mode/PHS mode) in which a mobile communication control center not illustrated governs cell base stations 2a.

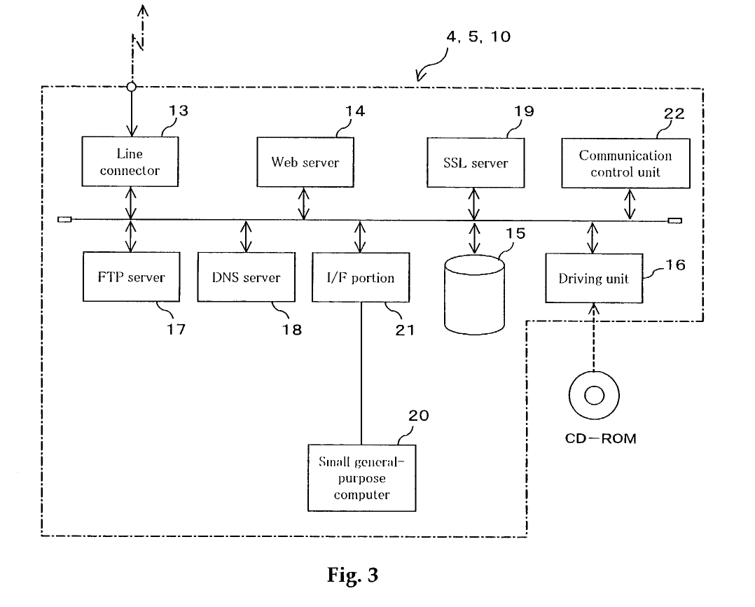

FIG. 3 is a block diagram to show the constitution of the important components of general server's web site communication system 4, net banking communication system 5 and local server web site communication system 10.

The system shown in FIGS. 1 to 3 constitutes a local area network (LAN) working on Ethernet. This Lan system has a connection unit 13 to connect the LAN with an ISDN (digital stationary communication network 1). The connection unit 13 consist of a router not illustrated here incorporating a digital stopper unit (DSU) or a fire-wall application for preventing the entry of unauthorized users.

This LAN system further contains a web server 14 for supporting communication on an Internet, and a database unit 15 for storing various data necessary for the achievement of “Internet-based service of integrative point management of this invention,” and through which a shop can search the data of a given desired customer.

The LAN system also contains a driver unit 16 which reads a program necessary for executing “Internet-based service of integrative point management of this invention,” from a CD-ROM and installing it to web server 14.

The LAN system further contains an FTP server 17 for file transfer on FTP (file transfer protocol), and a DNS server 18 for a domain name system (DNS). The LAN system further contains an SSL server 19 working on an SSL (Secure Sockets Layer) to be of use for the transfer of personal data which is installed for completing a transaction by the use of a debit card, credit card or c-cash as an “Internet-based service of integrative point management of this invention.” The LAN system further contains, together with a small, general-purpose computer 20 and an interface (I/F) circuit 21, communication control equipment 22 necessary for maintenance of the database.

The LAN system may further contain a LAN server for executing a LAN sequence, and another I/F circuit serving as an interface connector. The web server 14 may contain a fire-wall application for preventing the entry of unauthorized users, a server exclusively dedicated to the execution of the fire-wall application, and an E-mail server and a facsimile (FAX) server. The constitution of the LAN system may be determined as appropriate depending on the (quantity of data traffic to be transmitted, quantity of data traffic to be processed, and data transmission mode. In other words, any one of the general server web site communication system 4, net bank communication system 5 and local server web site communication system 10 can take a widely varied constitution on a network. For example, the LAN system shown in FIG. 3 may be constituted of a small, general-purpose computer alone, and is not limited to the one shown in the figure.

The small, general-purpose computer 6 shown in FIG. 1 may be a desk-top, tower-shaped personal computer or a portable computer whose constitution is known in the prior art. For example, such a computer may be constituted of a connector unit, micro-computer, flush memory, driving unit of a medium for recording data, monitoring unit, input handling unit, hard disk, etc. The cellular phone 3 of FIG. 1 may work on PDC or PHS mode, and its constitution is well known. For example, the cellular phone may be constituted, as is known in the art, of a wireless communication unit containing a frequency switching synthesizer and received sensed signal intensity (RSSI) detector, a mulitplexer based on modulation/demodulation/time-splitting, a microprocessor, an interface (I/F), a memory, a key-pad, an indicator such as a light-emitting diode to indicate the arrival of a call, a microphone for speech, and a speaker for hearing. The above explanation concerns with the hardware of the system.

Next, description will be given about the operation of this embodiment.

Firstly, description will be given how data are transmitted in the digital stationary communication network 1 (1a, 1b) and in the digital mobile communication network 2 configured as above.

Data are exchanged between the digital stationary communication network 1 and the elements connected thereto shown in FIG. 1, as IP packets running at a bit rate of 64 kbit/s, 384 kbit/s, or 1.5 Mbit/s. Transmission of data at 64 kbit/s occurs on a 2B+D mode (information channel at 32 kbps×2 and control channel at 16 kbps) with a packet conversion procedure X.31 (I.430/I.431, Q.921/Q.931, X.25 protocol) as recommended by ITU-T. The data transmission may occur at a higher bit rate transmission mode (for example, asymmetric digital transmission), or a higher communication mode (for example, gigabit high speed data transmission mode).

Each system shown in FIG. 1 can execute communication on TCP/IP well known for the communication through Internet; process data based on HTML (Hyper Text Markup Language) (process data to turn them into a text or voice, or compressed data to turn them into a JPEG still image or an MPEG animated image); transfer/receive data using a hyperlink function based on HTTP (Hypertext Transport Protocol); transfer a file using FTP; and execute an application installed in an external unit via CGI (Common Gateway Interface). Each system incorporates an application (web browser) for making E-mail communication and gaining access to an Internet.

The data one can fetch from the database using a database search engine occurs in a CDF (push-type data distribution format) or a push-pull type data distribution format based on XML (Extensible Markup Language), and are served on an animated home-page based on ASP (Active Server Pages). The data may further occur in a TIFF (Tagged Image File Format) which is used for storing a bit map file where a photo of a shop good is processed together with an accompanying text (merchandise catalog); or as a PDF (Portable Document Format) file suitable for reproducing a high-resolution image which maintains the quality of initial image irrespective of the type of unit or of font used for display.

Each system transmits files by means of bidirectional communication (streaming) in IP packets by a known method based on TCP/IP. Transfer of files on an Internet is carried out on an object-indication HTTP (instruction given to a radio-button, anchor, push-button, etc., by way of a coordinate input system such as a click or mouse). In this case, the file is made to contain, on the file format, a description end letter (FIN) and acknowledge character (ACK) for marking the opening of TCP connection, so that the file transfer may be smoothly achieved.

The general server's web site communication system 4, net banking communication system 5, and local server's web site communication system 10 shown in FIGS. 1 and 2 exercises, through the invention of a web server or a LAN server not illustrated here, a series of procedures necessary for the execution of “Internet-based service of integrative point management of this invention.”

The small, general-purpose computer and LAN system shown in FIGS. 1 and 2 execute “Internet-based service of integrative point management of this invention” based on a communication protocol and program carried out by the CPU (including that of the web server). The communication protocol and program, together with the aforementioned general-purpose communication protocol and program, serve as a program dedicated for the execution of “Internet-based service of integrative point management of this invention” for each system.

The digital mobile communication network 2 and cellular phone 3 shown in FIG. 1 achieves communication on a TDMA mode, TDMA/TDD communication mode, or CDMA mode according to ARIB-27/28 Standard, IMT-2000. According to this mode of data transmission, for example, voice data and character data are transmitted on a 1 or 2 time slot mode. If a cellular phone 3 moves into the service area of a cell base station 2a, the station monitors the control channel (CCH) of the phone by scanning it, and adds thereto a control channel ensuring a highest electric field for receiving signals. After the new registration has been made, the same communication sequence is introduced each time call is dispatched or received.

The general server's web site communication system 4 shown in FIG. 3 manages the data of memberships, as will be described later, using a membership data management module, and provides the attribute and acceptance data of a given member. It also manages the data about the point acquisition, point consumption, and point balance for each member using a point management module, as will be described later. By using a gift exchange module, it further allows a customer to obtain a gift in exchange for the points he/she possesses, as will be describe later. In addition, it provides local servers and membership retailers with various kinds of data or managing functions. It still further performs the maintenance of the membership data management module, point management module, gift exchange module contained in the general server's web site communication system 4 from a remote place (for example, an office or a headquarter of an enterprise responsible for the management of the general server).

The systems and components shown in FIGS. 1, 2 and 3 have been described for their operation.

Next, description will be given about the steps necessary for the execution of “Internet-based service of integrative point management of this invention” and data processing involved.

Firstly, (A) an overview will be given and then (B) important components among those mentioned in the overview will be described more in detail.

(A) General Overview

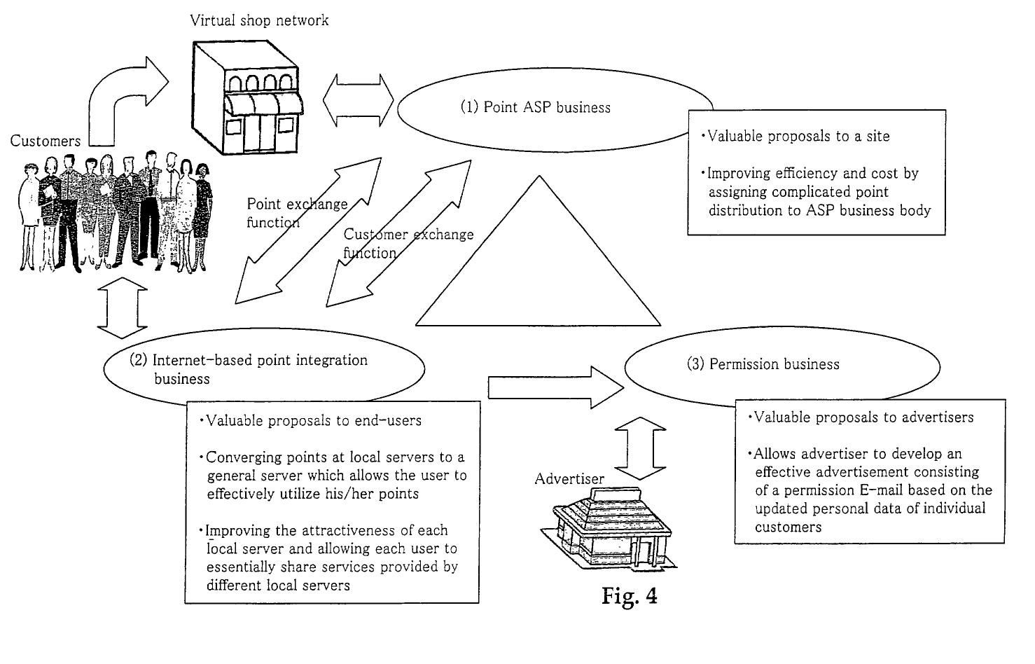

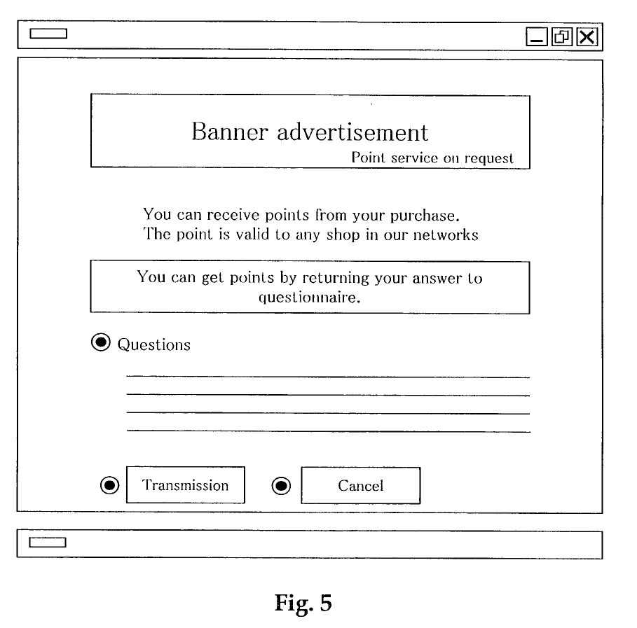

FIG. 4 illustrates the outline of the steps required for the execution of “Internet-based point integration service performed according to this invention,” and FIG. 5 illustrates another business method (advertisement).

In FIG. 4 a point ASB business body (general server's web site communication system 4) performs, through an Internet, point distribution service for a plurality of virtual shop networks Vsn each carrying out its own point distribution for commercial web site communication systems 10 (to be referred to as virtual shop as needed) belonging to it, as an organizer organizing those networks on an Internet. Through this organization, it is possible for a customer (via a cellular phone 3 or a small general-purpose computer 6) belonging to a local point distributor (local server of a virtual shop network Vsn) to make a shopping at more shops than would be possible if the local point distributor remained isolated. The details of how this becomes possible will be explained below in paragraphs (1), (2) and (3).

(1) Point ASP Business Body

The point ASP business body serves as an organizer to organize a plurality of local point distributors (virtual shop networks Vsn) via its general server's wel) site communication system 4, thereby managing/handling point distribution among different local point distributors, and its business includes followings.

Point management service for each virtual shop (commercial web site communication system 10 belonging to a virtual shop network Vsn)

efficient point accounting which is complicated on behalf of each virtual shop.

(2) Internet-based Point Integrative Management

Points managed by local point distributors (local servers each serving for a virtual shop network Vsn) are converged to the general server (general server's web site communication system 4) for integrative management, thereby promoting the effective use by the customer.

Through this arrangement, a point possessed by a local server of a virtual shop network Vsn becomes commonly valid to all the other local networks, and thus the point becomes more valuable for the customer than would be if the point only circulated in a single network.

Because a point is valid to shops belonging to different virtual shop networks Vsn a user can effectively use the point, regardless of whether it comes from his/her local point distributor (local server of a virtual shop network Vsn) or another. This in turn will lead to the increased purchase from the shops belonging to the virtual shop networks here concerned.

(3) Permission Business

The virtual shop can collect information of the personal attributes of a given customer updated over time, and thus develop a permission-based advertising based on his/her personal data.

FIG. 5 illustrates how advertisement is presented to a customer on a web site. The advertisement shown in FIG. 5 presents the customer, for example, with: a banner advertisement of the advertising virtual shop; its being ready to publish points for purchase; the points being exchangeable on Internet; and the points being usable in another shop belonging to a different local server via Internet. Because the virtual shop ensures the customer, via the display, that the customer can enjoy discounted purchase at many shops, it will have more chances to capture a group of stable customers.

If it is displayed that a customer will be given some points when he/she send an answer in a questionnaire survey, the customer will be interested, and a larger number of customers will gain access to the advertisement than would be otherwise. This will lead to the increase of potential customers of that shop.

(B) Detailed Description of the Important Components Among Those Mentioned in the Overview

Firstly, description will be given about (1) point ASP business body (general server's web site communication system 4)

The point ASP business body provides an integrative management service to local point distributors (local servers each serving for a virtual shop network Vsn). The detail of the service is as follows.

Provision the virtual shop network Vsn with point management function

Provision each shop with a function to publish a point for a purchase or other reward worthy acts by a customer

Allows each customer (user of a small general-purpose computer 6 or cellular phone 3) to make a shopping based on the points available to him/her. Allows each customer, when he/she buys a good or service from a shop, to pay points instead of money, and calculates the points the shop got, and the points the customer lost, i.e., keeps the point accounts of both the customer and the shop.

Responds to questions from customers including his/her point balance.

Collects information of customers and manages it.

The detail of the above services will be given below.

The point ASP business performed by a single or plural general servers (general server's web site communication system 4) will be referred to as “assigned point distribution service according to this invention” for brevity.

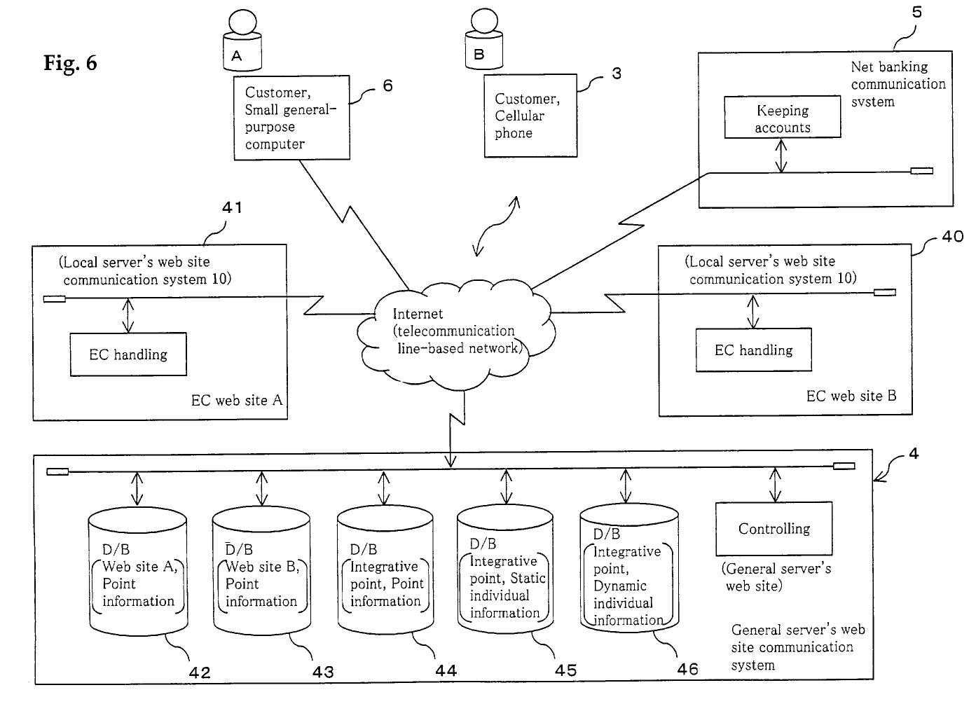

FIG. 6 is a block diagram to show how point ASP businesses are mutually related.

A general server web site 50 (general server's web site communication system 4) shown in FIG. 6 contains point data databases 42, 43 (database unit 15 of FIG. 3) corresponding respectively with EC web sites A41, B40 (local server's web site communication systems 10 each for serving a virtual shop network Vsn) which have assigned the point ASP business to the general server.

The point data databases 42, 43 store/manage respective data separately, and serve as an element of the “assigned point distribution service according to this invention” for EC web sites A41, B40. Exchange of point information through the intervention of point data database 42, 43 is achieved via a communication network (Internet) between customers A, B (cellular phone 3 or small general-purpose computer 6) and EC web sites A41, B40. The point information, when the customer makes a shopping at a shop of a virtual shop network Vsn, is immediately sent by the local server's web site communication system 10 responsible for the network, to the databases 42, 43 (database unit 15 of FIG. 3), while daily batch treatment results are sent by EC web sites A41, B40 to the general server's web site 50.

The general server's web site 50 receives fee for the service from EC web sites A41, B40. The fee depends on the amount of services provided, or is a constant sum for the use of a definite period. On a period-based fee, for example, the general server collects the fee monthly or annually. On a use-based fee, the general server collects the fee from a local server depending on the number of registered members of its network, or the amount of points fed and extracted by the local server. The fee may be determined by the amount of use in excess of a certain basic level (the local server must pay the basic fee even if it does not use the service).

The general server provides customers A, B (cellular phone 3 or small general-purpose computer 6) with point exchange service. Points valid to EC web site A41 and pints valid to EC web site B40 are exchangeable between customers A and B. The point exchange service provided at the general server's web site 50 is as follows.

Customers A, B (cellular phone 3 or small general-purpose computer 6) can open integrative accounts on the general server's web site 50.

Allows customers A, B to provide necessary data on the general server's web site 50 when they make membership registration, other customers as well as the customers in question to view the data, and the customers to update the data.

Allows customers A, B to exchange a point obtained under the contraction with the general server for a point stored in the integrative account, or to exchange a point obtained from a local server they contracted with for a point provided by a different local server.

Allows customers A, B to check their current balances of their integrative accounts.

Allows customers A, B to buy a good in exchange for the points stored in their integrative accounts, that is, to buy a good or service by paying the points equivalent to the price of the good, instead of paying money.

Allows each of customers A, B to make a transaction with another customer on Internet, consisting of exchanging the points of the former for those of the latter.

Collects updated information of the personal attributes of each of customers A, B, and allows a shop to develop a permission marketing activity towards individual customers based on their personal data.

Allows a shop to open a (banner) advertisement on its web site.

The essence of the service practiced by the general server will be referred to as “Internet-based point integration service according to this invention” for brevity.

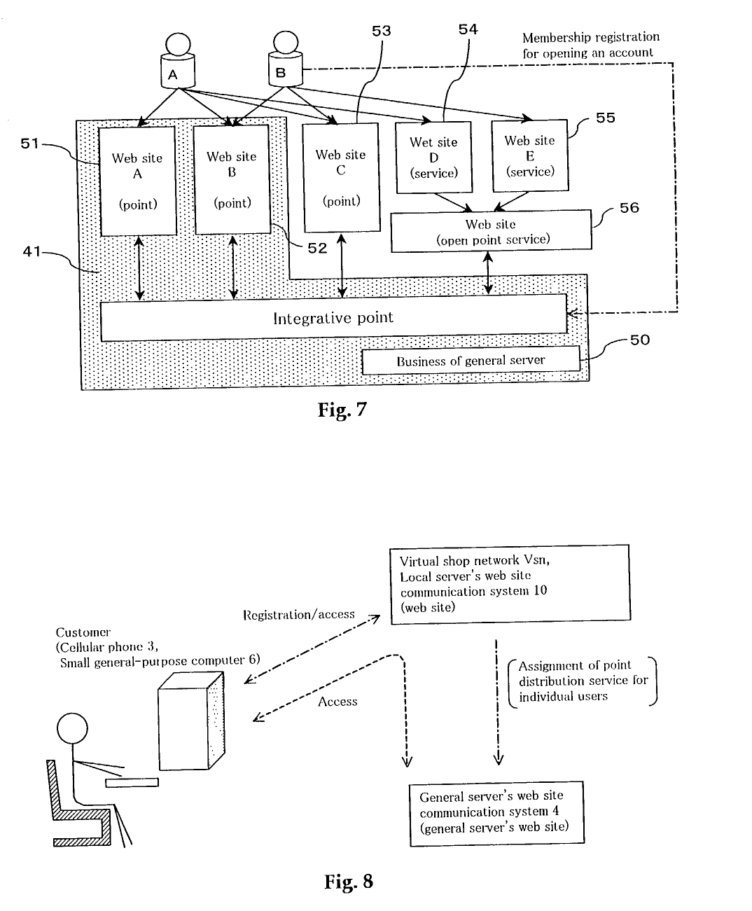

FIG. 7 illustrates how Internet-based point integration service is performed.

FIG. 7 shows an organization where a general server manages/handles (integrally manages for brevity hereinafter) businesses performed by a plurality of separate local servers: in this particular example, web site managers (participant servers A to E) execute the “Internet-based point integration service according to this invention.” A web site manager (one of the participant servers A to E) corresponds to a local server's web site communication system 10 serving for a virtual shop network Vsn. A customer, after he/she registers as a member of a local network managed by a web site manager, can receive the point service provided by the web site manager.

The point service may consist of allowing the customer to use, based on the point information obtained on Internet, a point received from a virtual shop for a purchase from an actual shop corresponding to the virtual shop. The point service may further consist of allowing the customer to receive a point from a marketing research institute for giving an answer to the questions asked by the institute.

Web site managers A51, B52 shown in FIG. 7 assign their point service to the general server on its web site 50 which incorporates it as one or its ASP businesses, while a web site manager C performs the point service by itself (outside its virtual shop network Vsn). Web site managers D54, E55 do not provide the point service themselves but contract with web site manager 56 which provides a universal point service. When the universal point service is available, customers A, B can receive point service through an integrative point exchange.

Besides these embodiments, there may be a case where a customer can receive a point service from a common shop which publishes its own points, as long as the point data of the shop are stored/managed on a database and the data there are accessible from the general server.

Customers A, B can receive point service from any one of web site managers A51 to E55, by opening an account on the general server web site 50. The general manager at its web site 50 watches the traffic of points through web site managers A51 to E55, and records the traffic data. A point transmitted by any one of web site managers A51 to E55 to the general server's web site 50 may be compared to a point the web site manager buys from a customer, and thus the point is delivered to the account of the customer on the general server's web site. A point transmitted by the general server to any one of web site managers A51 to E55 may be compared to a point the web site manager buys from a customer. On this promise, the balance is calculated. The result is provided to the account daily or at regular intervals, e.g., on a monthly basis. At the termination of the interval, the final balance is determined.

Next, customers A, B call exchange their points on Internet. Customers A, B open their accounts on the general server's web site (general server's point accounts). A customer having a general server's point account can make a transaction with another customer having his/her own point account: the former may transfer points there to the latter's account for free, or in exchange for an equivalent sum of electronic money through the intervention of a net bank like the one described with regard to FIG. 5 (net banking communication system 5 of FIG. 1).

The aforementioned “Internet-based point integration service according to this invention” will be detailed below.

FIG. 8 illustrates the processing performed by the general server at its web site 50 (see FIG. 7), particularly procedures exchanged among the customer (cellular phone 3 or small general-purpose computer 6), EC web site manager 41 and general server web site 50.

As described with respect to FIGS. 6 and 8, customers A, B subscribe respectively to EC web site managers A41, B40, and thus are the members of the networks managed by the managers. EC web site managers A41, B40 assign the general server to perform “assigned point distribution service according to this invention” for them. The general server has at its web site 50 (general server's web site communication system 4) databases 42 to 46 (database unit 15 of FIG. 3) separately assigned to EC web sites A41 to B40

When customers A, B buy a good or service from a shop in the network managed by EC web site manager A41, B40, the EC web site manager gives points to customers A, B depending on the sum of purchase. Information of the point provision is immediately transmitted to the general server's web site communication system 4 to be stored in the corresponding database 42, 43 or 46, and the points assigned to customers A, B are updated. During this procedure, customers A, B are not conscious of the existence of the general server (general server's web site communication system 4), but can follow their current point balances by watching the display provided at the home page of EC web site manager A41, B40.

As seen from above, customers A, B obtain their necessary information from either EC web site A41 or B40. Namely, a customer can equally gain access to a plurality of virtual shop networks Vsn.

Referring to FIG. 8, if customers A, B wants to use points from a shop of a local network for a purchase from another shop belonging to another local network, customers A, B must open an account on the general server's web site 50 (general server's web site communication system 4). The procedure necessary for the opening of an account includes providing information of the personal attributes of the customer including his/her name, address, phone number, gender, E-mail address, etc., and the information is stored in the database 45 (integrative point stationary information database) at the general server's web site (general server's web site communication system 4). Customers A, B can freely gain access to the information to update it.

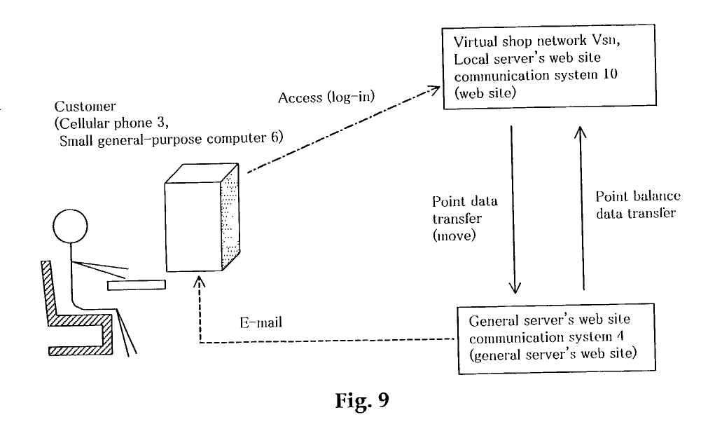

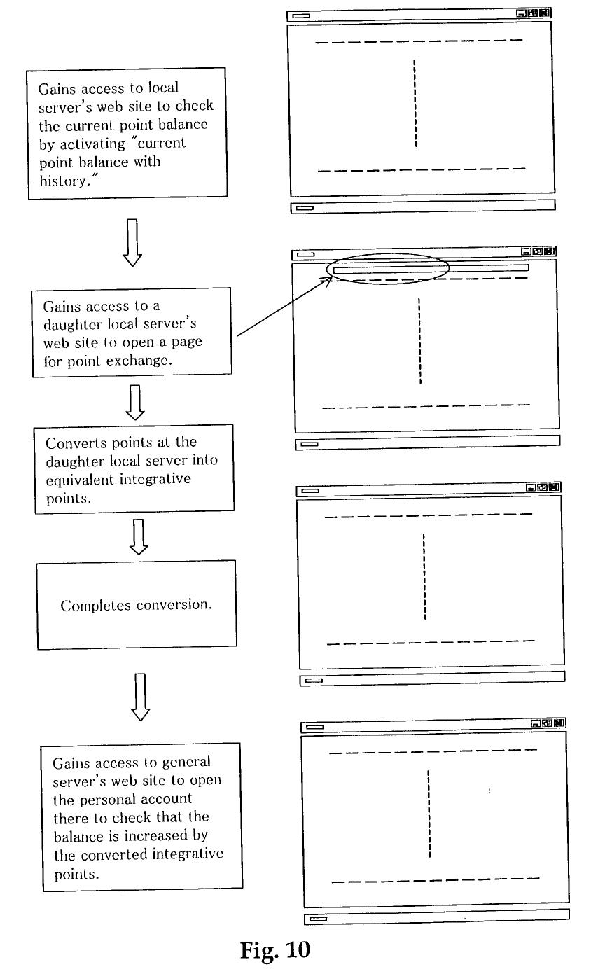

FIG. 9 illustrates how points are exchanged, and FIG. 10 illustrates the flow of steps necessary for point exchange.

FIGS. 9 and 10 show how points provided by EC web site managers A41, B40 are exchanged at the general server's wet site 50 (general server's web site communication system 4).

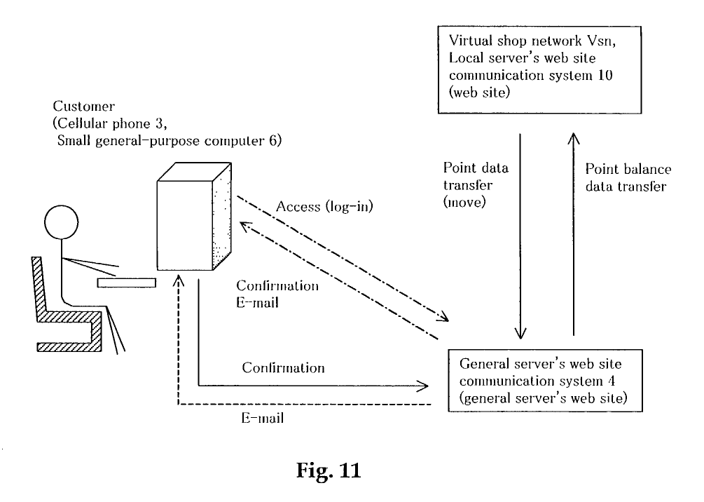

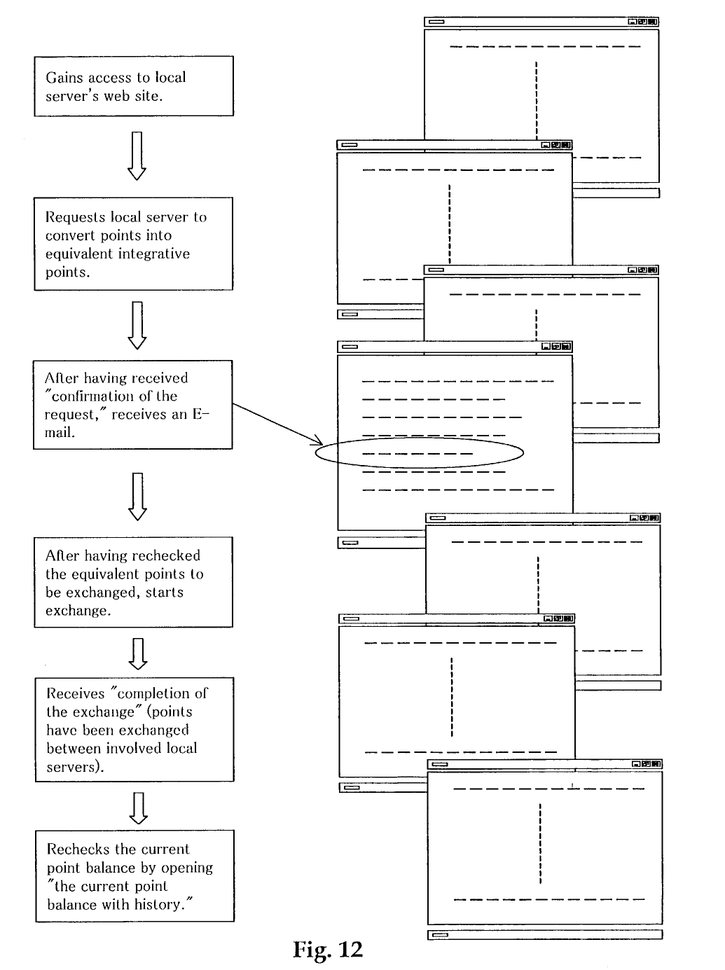

FIGS. 11 and 12 illustrate the flow of steps necessary for the general server to exchange points between different local servers. Customer A, B check their current point balances on the general server's web site, want to move a point from a local network to another local network, and dispatch a request on the general server's web site. On receipt of the request, the general server sends an E-mail to the registered address of customers A, B. On receipt of an affirmative response from customers A, B, the general server moves the point as requested. This is to prevent the unauthorized use of the point account of customers A, B.

FIGS. 9 and 10 show a case where a customer moves a point from the network managed by EC web site manager A41 to the network managed by EC web manager B40 through the intervention of the general server at its web site 50 (general server's web site communication system 4).

If customer A wants to convert his/her points accumulated at EC web site A41 into equivalent points valid to the network managed by EC web site manager B40, he/she gains access to the general server's web site 50 and knows the conversion ratio from lists of data presented there. The same holds true if a customer wants to convert his/her points accumulated at EC web site B40 into equivalent points valid to the network of EC web site manager A41. A general procedure for conversion consists of converting points at EC web site A41 into integrative points it the general server's web site 50 to be stored there, and then each time the customer buys a good or service from a shop under EC web manager B40, the integrative points are further converted into points valid to EC web site B40 and sufficient to meet the purchase. Needless to say, the conversion may take place directly between the two EC web sites without the intervention of integrative points.

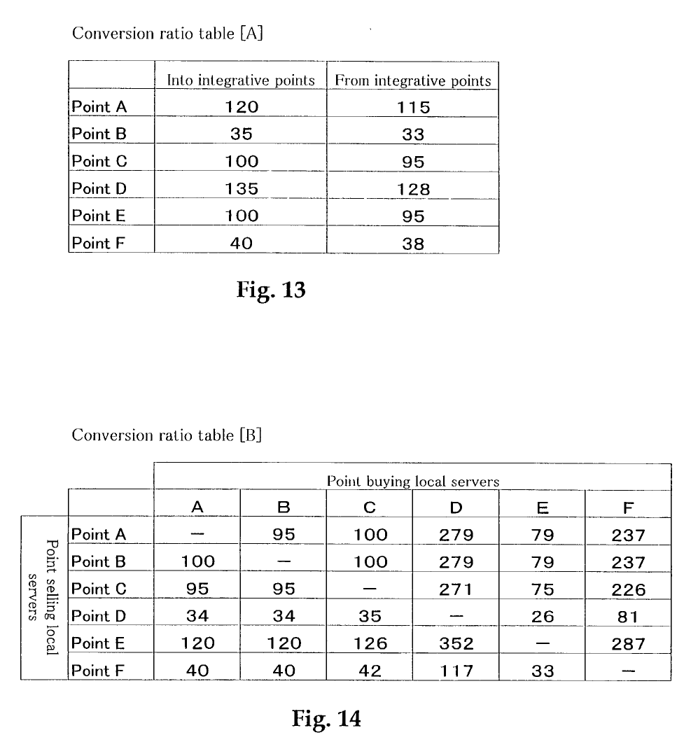

FIG. 13 is a table-form figure to show a list of point conversion ratios.

Customers A, B, if they want to convert a point valid to a local network into a point valid to another local network as discussed above with reference to FIG. 9, can find the relevant conversion ratio by referring to a table of conversion ratios [Conversion ratio table A] shown in FIG. 13. This table lists conversion ratios (120-40) to be applied when a point of a local network A to F (each of virtual shop networks Vsn) is converted into an equivalent “integrative point,” together with conversion ratios (115-38) to be applied when an integrative point is converted into an equivalent point valid to a local network A to F (each of virtual shop networks Vsn). For example, if a point of a local network B is converted into an equivalent integrative point, the conversion ratio of “35” should be applied (point 1 is converted to points 35). Conversely, if an integrative point is converted in an equivalent point of the local network B (one of virtual shop networks Vsn), the conversion ratio of “33” should be applied.

As long as based on the conversion ratios listed on this table, the points of a customer gradually decrease each time conversion takes place (conversion decrement). The conversion ratios may be adjusted to eliminate the conversion decrement, to be of service to customers A, B. The conversion ratios may be kept constant. Alternatively, the conversion ratio between the point of a local network and the integrative point may be altered according to the popularity of that local network, to add a sporting taint. This may stimulate the interest of customers A, B, and promote the sale of the shops in the local networks (virtual shop networks Vsn).

Point conversion based on the ratio listed in [Conversion ratio table A] will be illustrated by means of an example.

Customers A, B, if they want to move points from a local network A to another, gain access to the general server's web site 50 (general server's web site communication system 4) to check the relevant conversion ratio; and convert all the points accumulated at the local server B into equivalent integrative points. The conversion data are stored in the database 44 (database unit shown in FIG. 3) as shown in FIG. 6. Customers A, B convert similarly points accumulated at other local servers into equivalent integrative points, and then transmit the integrative points to EC web site A41 of FIG. 6 at a certain timing. Through this operation, it becomes possible for customers A, B to receive a service available to the local network managed by web site manager A41 by paying the points accumulated there.

FIG. 14 is a table-form figure to show another list of point conversion ratios.

The [conversion ratio table B] of FIG. 14 applies to a case where conversion is directly made between local networks. In this [conversion ratio table B], listed are conversion ratios between different local networks A to F (virtual shop networks Vsn). A 100 points of local network B corresponds to 100 points of local network A.

The conversion ratios of [conversion ratio table B], like those of [conversion ratio table A], are set such that points possessed by a customer gradually decrease each time conversion takes place. The conversion ratios may be adjusted to eliminate the conversion decrement, to be of service to customers A, B.

According to the conversion ratios listed in [conversion ratio tables A and B], conversion takes place by 100 points. However, this is modified such that conversion may take place by 1, with a due consideration paid to odd numbers below 1. It may be possible to encourage customers to accumulate points at a certain local network out of local networks A to F, by setting the conversion ratio so as to cause conversion to take place by 100 points.

Next, description will be given how the current information of the personal attributes of individual customers is collected, and how the information is made available to shops and customers.

As described above, customers A, B obtain a point from a purchase at a shop in a virtual shop network Vsn (local server s web site communication system 10). The purchase is a sheer personal activity of the customer. By the way, the personal data of the customer include, for example, his/her address and name, gender, age, E-mail address, as well as position in his/her company, social status including qualifications, personal taste including favorable brand good, favorable season, etc.

Information of a given person regarding his/her personal taste and social status is fairly easily obtainable. For example, such information can be obtained by referring to his/her application which the customer presented prior to the registration as a membership or receipt of a credit card. The characteristics of customers involving the behavior in shopping are so widely varied that a simple questionnaire survey will not bring any significant information. Moreover, people often buy a good being urged by a momentary impetus.

In this embodiment, it is possible to collect the personal data of a given customer by following the items purchased by him/her at shops of the virtual shop networks Vsn (purchase), point exchanges performed by him/her, and his/her accesses to banner advertisements, and by storing the thus collected data together with the ID of the customer. The personal taste and social status of a customer changes over time. To meet this situation, servers may send a questionnaire to customers at regular intervals. This is achieved by sending an E-mail directly to the customer, or by obtaining directly the personal data from a customer on the server's home page in exchange for a point.

Thus, it is possible to update information of the personal attributes of individual customers. Thanks to the data, the shop can send an effectively matching mail directly to a given customer.

When the shop-keeper searches through the database using a database search engine to find advertisements significantly matching with a given customer, the shop must pay a close attention to how the personal attributes of the customer to be used for the search should be weighed. For example, to enhance the advertising effect if the shop-keeper limits the personal attributes based on which search will be made, to a few, the advertisement prepared based on the search will be applicable to a limited number of customers. In other words, the advertisement will have less side effects. Generally, as limitation on personal attributes based on which search will be made is relaxed, the advertisement based on the search will fit to more customers, which may then cause a cost-effect problem.

The above embodiments have been explained on the premise that the unit the customer uses consists of a small general-purpose computer 6. However, the user, even if his/her unit is a cellular phone 3 containing a web browser, can similarly enjoy the “Internet-based point integration service according to this invention.” However, if the user uses a cellular phone 3 as his/her communication unit, and wants to send data through the display of the phone, it will be necessary to use an editing server 7 as in shown in FIG. 1, thereby enlarging the display, because the display of the phone is usually too small for the user to feed input therethrough.

The user may use a cellular phone 3 working on a mode different from that of a common cellular phone that alone allows the user to make Internet surfing. For example, the user may use a unit obtained by connecting a mobile computer with a web browser enabling the user to make Internet access, to a cellular phone having no browser. The user may use a unit obtained by connecting a small display via a wireless interface to a cellular phone working on a special mode provided by IEEE.

In this embodiment, if the local server, when it sends a display (file) to a user, can boot up an SSL server 19 depending on the content of the display, thereby keeping the secrecy of the content of the display from other users, the security of the network will be insured. For example, unauthorized use of the personal data of users may be safely prevented. Besides such encryption, a security procedure may be introduced for the transaction via the net banking communication system 5: the procedure requires both the money payer and the money receiver to present their IDs and pass-words. Further security measures may be introduced as needed, for example, against eavesdropping (unauthorized tapping of data on a communication line), interception (intercepting the transmission of data), manipulation (manipulating data on transmission), disguise (intentionally disguising as another user without consent from the user), etc. The security measure may consist of introducing a conventional encryption system or a public key encryption/RSA, MH), thereby preventing the personal data of users from being exposed to the risk of undue destruction.

The above embodiments have been described on the premise that the system is constructed on an Internet having an open publicity. However, the network may be a local communication network which is available only to a limited number of retailers or groups. For example, the network may be an intranet. Or, the network may be an extranet, that is, a network obtained by connecting a domestic network to a foreign network. Then, the users of different countries could enjoy “Internet-based point integration service according to this invention.” via the network.

Industrial Applicability

According to this invention, a plurality of independent local servers are organized under a general server via a computer-based bidirectional communication network (Internet) operating under a TCP/IP environment, the general server performing point distribution between different local servers and keeping the balance of point transactions introduced between different local servers, thereby relieving the local servers of complicated works. A membership retailer or shop-keeper can collect the updated personal data of individual customers by referring to point exchanges or point transactions presented at the general server's web site, and thus can develop an effective direct marketing consisting of sending appropriately chosen E-mails to customers based on their personal data on a timely manner.

1. A management method of premium points useful for a plurality of virtual shops working on a computer-based bidirectional communication network wherein a customer receives a premium point under the management of a general server, comprising:
a step in which the general server performs point distribution which would be otherwise performed by each of the plurality of virtual shops, or through the cooperative action of the virtual shops;
a step in which the general server receives through its web site, when a customer receives a point from a shop, the ID signal of the customer sent via the customer's communication unit, and the date when the customer received the point, the ID signal of the virtual shop which published the point, and the data including the total points the customer has received heretofore; and
a step in which the general server at its web site stores the thus received data.

2. A management method as described in claim 1 of premium points useful for a plurality of virtual shops working on a computer-based bidirectional communication network wherein a customer can make, with another customer, a transaction consisting of exchanging his/her point for money or an equivalent point valid to another shop belonging to a local network other than that to which the customer belongs, at the web site managed by the general server.

3. A management method as described in claim 1 or 2 of premium points useful for a plurality of virtual shops working on a computer-based bidirectional communication network wherein, in said transaction, the point possessed by the first customer is converted to an equivalent integrative point managed by the general server on the web site managed by the general server.

4. A management method as described in claim 1 or 2 of premium points useful for a plurality of virtual shops working on a computer-based bidirectional communication network wherein a customer can exchange a point which he/she has received from a shop for another point valid to another shop through a process performed on the web site managed by the general server.

5. A management method as described in claim 3 or 4 of premium points useful for a plurality of virtual shops working on a computer-based bidirectional communication network wherein said exchange of one kind of point for another is carried out based on a conversion rate constant or changeable as needed over time provided by the general manager on its web site.

6. A management method as described in claim 3 of premium points useful for a plurality of virtual shops working on a computer-based bidirectional communication network:
wherein, to be qualified for making a transaction with another customer consisting of the exchange of points and receiving, alter the transaction, a desired point through his/her communication unit, a customer must apply for a membership by sending information of his/her personal attributes to the general server through its web site; and
wherein the general manager stores the information of his/her personal attributes in order to make the information available for direct marketing.

7. A management method as described in any one of claims 1 to 3 of premium points useful for a plurality of virtual shops working on a computer-based bidirectional communication network wherein a virtual shop collects updated information of the personal attributes of individual customers by referring to the point collection of customers, the point exchange transactions between customers, and the results of questionnaire-based surveys.

8. A management method as described in claim 6 or 7 of premium points useful for a plurality of virtual shops working on a computer-based bidirectional communication network wherein a virtual shop extracts advertisement information appropriate for a given customer by searching through a database using a database search engine based on the updated information of the personal attributes of the customer, and develops a permission marketing directed to the customer consisting of an E-mail containing a direct mail, based on the extracted advertisement information.

9. A communication system for managing premium points exchangeable among a plurality of virtual shops working on a computer-based bidirectional communication network comprising:
a local server's web site communication means which performs point distribution on behalf of virtual shops under its coverage, and receives, for each customer who receives a point, the data regarding his/her ID, the date when he/she received the point, the ID of the shop giving the point to the customer, and sends the data to a general server;
a customer's computer-based communication unit which receives the point from the virtual shop via the local server's web site communication means, and uses the point stored by the general server for a purchase at any desired virtual shop covered by the general server; and
a general server's web site communication means which receives data sent by the local server's web site communication means to store, and by which the general server, for each transaction involving two shops belonging to different local servers' networks, finds the previously published points and the currently consumed points for the two shops, and determines by subtraction the resulting points for the two shops, and transmit the results to the relevant local servers.

10. A communication system as described in claim 9 for managing premium points exchangeable among a plurality of virtual shops further comprising, on the computer-based bidirectional communication network, a network-based banking communication means which determines the price of a given good at a shop, or the corrected price of the good if a point is presented by the buyer prior to the purchase.

11. A communication system as described in claim 9 for managing premium points exchangeable among a plurality of virtual shops further comprising, on the computer-based bidirectional communication network, a remote maintenance communication means which performs, from a remote site, the maintenance work of the general server's web site communication means.

12. A communication system as described in claim 9 for managing premium points exchangeable among a plurality of virtual shops further comprising, in the general server's web site communication means, a database unit which stores the attribute data of a customer sent by his/her computer-based communication unit via the general server's web site communication means, and which allows a virtual shop to seek appropriate advertisement information for the customer using a database search engine based on the attribute data of the customer, and to develop a permission marketing directed to the customer consisting of an E-mail containing a direct mail, based on the thus extracted advertisement information.

13. A communication system is described in claim 9 for managing premium points exchangeable among a plurality of virtual shops wherein the computer-based communication means is a cellular phone incorporating an application enabling bidirectional communication, or a cellular phone not incorporating such an application connectable, however, to a small general-purpose computer with such an application, or such a small general-purpose computer.
